(19) United States
(12) Patent Application Publication
(10) Pub. No.: US 2015/0066610 A1
(43) Pub. Date: Mar. 5, 2015

(54) SYSTEM FOR ADMINISTERING AN INCENTIVE AWARD

(71) Applicants: Chris Morales, Hawthorne, CA (US); Antonio Flores Gonzalez, Guarbo, PR (US)

(72) Inventors: Chris Morales, Hawthorne, CA (US); Antonio Flores Gonzalez, Guarbo, PR (US)

(21) Appl. No.: 14/198,895

(22) Filed: Mar. 6, 2014

Related U.S. Application Data
(60) Provisional application No. 61/777,600, filed on Mar. 12, 2013.

(51) Int. Cl. G06Q 30/02

(52) U.S. Cl. CPC G06Q 30/0229
USPC 705/14.3

(57) ABSTRACT

A method for administering an incentive award system in which a bank issues a credit or debit card account to a participant and sets up an interest bearing account for the participant to receive the incentive award. Specific merchants are designated who have agreed to make awards of a specified amount to the participant. After sale of goods to the participant and charging the sales to the credit or debit card account, an award amount is determined based on the charges, which is sent to the issuing bank to be credited to the participant account. In preferred embodiments, the participant account has time restrictions against withdrawal of funds. In other embodiments, the award amount is determined by an oversight organization that calculates the mount of the award as a percentage of the transaction, which may be lower for non-merchant brands.

### FIELD OF THE INVENTION

The present invention generally relates to the field of computer programming and data processing systems for incentive programs.

### BACKGROUND OF THE INVENTION

Systems are known whereby when a customer is at the cash register of a retail establishment, such as in a supermarket, the cahier asks the customer if he or she would like to donate a specified amount to a particular charity on the customer's behalf. With the customer's consent, the specified amount is added to the customer's total and eventually is sent to the charity. Other systems are known that provide awards to customers, for example, the incentive award system in U.S. Pat. No. 6,222,914, incorporated herein by reference, in which a bank issues a credit card account to a participant, sales at the retail establishment are charged to the credit card account, an award is determined based at least in part on the charges, waiting to see if the participant is a good customer in good standing, then crediting the award amount to the credit card account.

### BRIEF SUMMARY OF THE INVENTION

The present invention is not contemplated by the foregoing systems. In accordance with the present invention, a method is provided hr administering an incentive award system in which a bank issues a credit or debit card account to a participant and sets up an interest bearing account for the participant to receive the incentive award. Specific merchants are designated who have agreed to make awards of a specified amount to the participant. After sale of goods to the participant and either charging the sales to the credit or debit card account or payment in cash, an award amount is determined based on the charges, which is sent to the issuing bank to be credited to the participant account. In preferred embodiments, the participant account has time restrictions against withdrawal of funds. In other embodiments, the award amount is determined by an oversight organization that calculates the mount of the award as a percentage of the transaction, which may be lower for non-merchant brands.

How credit or debit card charges are administered is shown at:

http://www.authorize.net/resources/howitworksdiagram, which is incorporated herein by reference and which describes how a gateway manages processing of the card transactions.

### BRIEF DESCRIPTION OF THE DRAWINGS

For a more complete understanding of the present invention, reference is now made to the following descriptions taken in conjunction with the accompanying drawings, in which:

FIG. 1 is a schematic process flow diagram of a preferred embodiment of the invention.

### DETAILED DESCRIPTION OF THE INVENTION

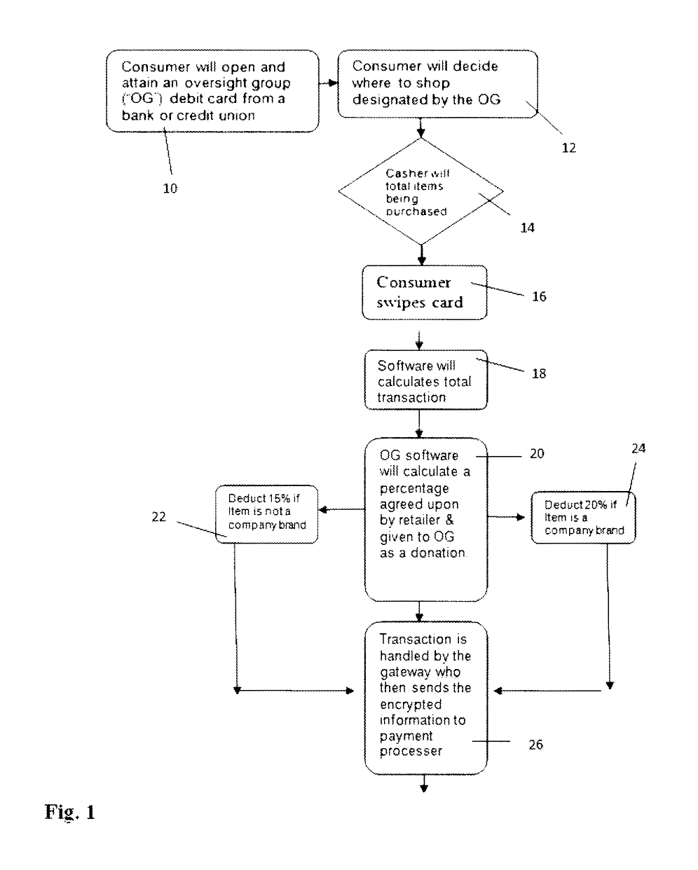

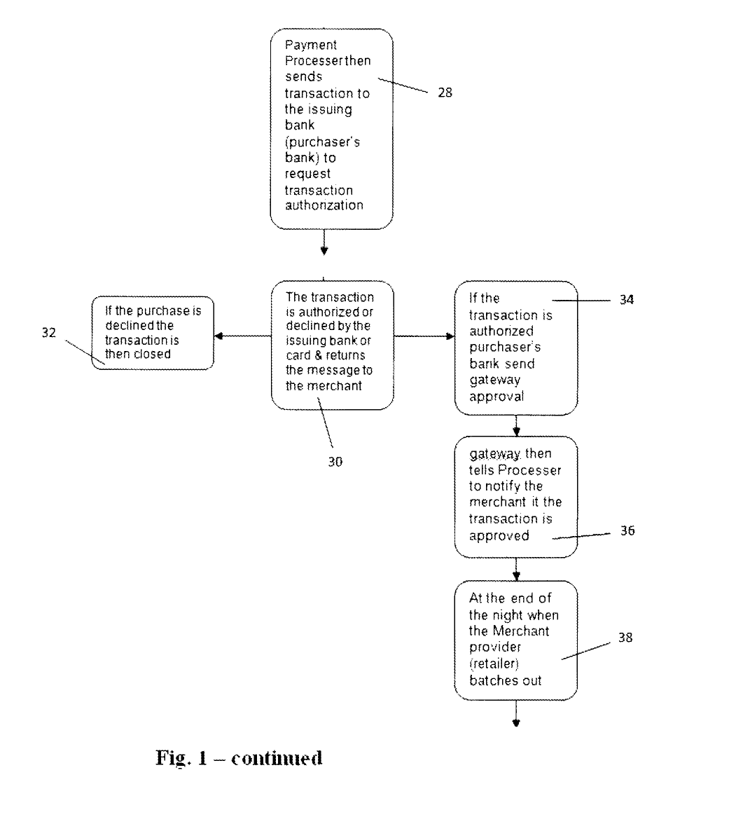

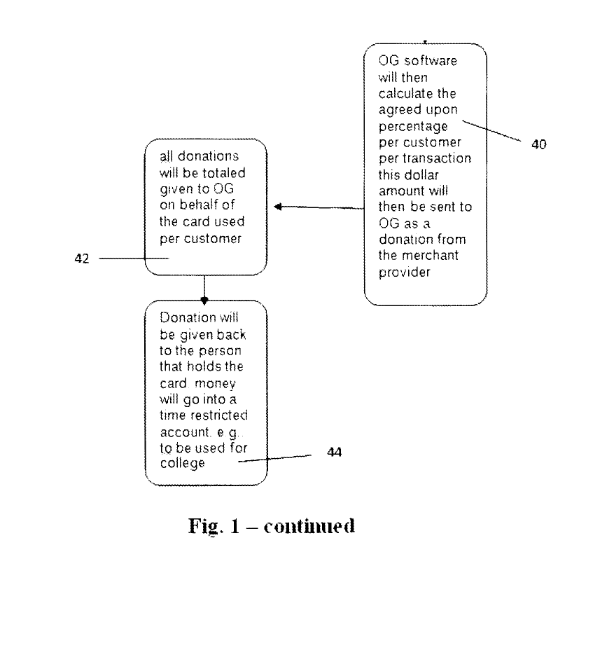

Referring to FIG. 1, there is illustrated a preferred embodiment process flow of the system and method of the invention. To start, as shown at 10, a participant opens and attains an oversight group (“OG”) credit or debit card, preferably a debit card from a bank or credit union. Alternatively, a rewards card can be obtained from the bank or credit union. The card comes with a list of designated merchants, such as a supermarket. The OG can be a nonprofit organization whose purpose is to facilitate college education funds.

As shown at 12, the participant (consumer) will decide where to shop from the list of designated by the OG. After shopping, at the check-out, the cashier will total the items being purchase, as shown at 14. The consumer swipes his or her card, at 16, whereupon software will calculate the total transaction, at 18.

As shown at 20, the OG software will calculate a percentage agreed upon by the merchant (retailor) and given to the OG as a donation. If the merchandize is a company brand then, as shown at 24, the OG software will deduct a first percentage, say 20%. However, as shown at 22, if the merchandize is not a company brand, the OG software will deduct a second, lower percentage, say 15%. In the case of a rewards card, the software will credit the card account with the relevant award.

As shown at 26, the transaction is handled by a gateway that then sends the encrypted information to a payment processor. As shown at 28, the payment processor then sends the transaction to the issuing bank (the purchaser/participant's bank) to request transaction authorization. As shown at 30, the transaction is either authorized or declined by the issuing bank or card, returning a message to the merchant. As shown at 32, if the purchase transaction is declined by the issuing hank, the transaction is closed. As shown at 34, if the transaction is authorized, the purchaser's bank sends the gateway its approval its approval. The gateway then tells the processor to notify the merchant, at 36.

As shown at 38 and 40, at the end of the day, or periodically, when the merchant batches out, the OG software will calculate the agreed upon percentage customer per transaction and this dollar amount is sent to the OG as a donation from the merchant. As shown at 42, all donations are totaled and given to the OG on behalf of the cards used per person. As shown at 44, donations will be given back to the person that holds the card, the funds to go into a time restricted account, for example, an account to be used as a college fund. The account can be in the name of the ultimate recipient of the funds, e.g., the future college student.

While the foregoing description has been with a nonprofit organization as the OG, the OG could be a for profit organization. In either case, funding for the organization can be by corporate sponsors, such as the merchandizers on the designated company list. Also, in either case optionally a small percentage, say 2-10%, of the funds can be paid to the OG for administration of the program.

Although the present invention has been described in connection with the preferred embodiments, it is to be understood that modifications and variations may be utilized without departing from the principles and scope of the invention, as those skilled in the art will readily understand.

1. A method for administering an incentive award system, comprising the steps of:
an issuing bank issuing a credit, debit card, or an award card to a participant;
the issuing bank setting up an interest bearing account for the participant to receive the incentive award;
designating specific merchants who have agreed to make awards of a specified amount to the participant;
A specified merchant selling goods to the participant;
if the issued card is a credit or debit card, charging the sales to the credit or debit card account;
determining an award amount based on the charges or cash paid; and
sending the award amount to the issuing bank to be credited to the participant account.

2. The method of claim 1 wherein the participant account has time restrictions against withdrawal of funds.

3. The method of claim 1 wherein the award amount is determined by an oversight organization.

4. The method of claim 3 wherein the oversight organization calculates the mount of the award as a percentage of the transaction.

5. The method of claim 4 wherein the percentage of the transaction is at a first percentage for merchandise that is a brand of the merchant and at a second percentage lower than the first transaction for merchandise that is not a brand of the merchant.

6. The method of claim 1 wherein the card is a debit card.

7. The method of claim 1 wherein the card is a credit card.

8. The method of claim 1 wherein the card is an award card.
